(19) United States
(12) Patent Application Publication
(10) Pub. No.: US 2026/0152333 A1
(43) Pub. Date: Jun. 4, 2026

(54) LID CONNECTION ASSEMBLY

(71) Applicant: The Stanley Works Israel Ltd., Rosh Ha'Ayin (IL)

(72) Inventor: Adar Omry, Hertzeliya (IL)

(21) Appl. No.: 18/967,143

(22) Filed: Dec. 3, 2024

(51) Int. Cl. B65D 51/24

(52) U.S. Cl. CPC B65D 51/24; B65D 2251/1008

(57) ABSTRACT

A latch assembly and storage systems having a latch assembly are provided. In one embodiment, the latch assembly is coupled to a housing and a lid on the housing. The latch assembly includes a connecting ring having a first portion disposed within a guide track in the housing and a second portion coupled to the lid. The first portion can be configured to move from a first region of the guide track to a second region of the guide track in response to movement of the lid from the closed position to the open position, and a protrusion extending at least partially into the guide track is configured to retain the first portion within the second region of the guide track to thereby retain the lid in the open position. The lid can be moved from the open position to the closed position in response to a force applied to the lid sufficient to cause the protrusion to deflect and thereby allow the first portion of the connecting ring to move from the second region of the guide track to the first region of the guide track.

### FIELD

A storage system including a mechanism for retaining a lid in an open position, and methods for using the same, is provided.

### BACKGROUND

Traditional storage systems typically include a container that has an internal volume, a lid, and some mechanism of connecting the container and the lid. A typical connection mechanism between a lid and a container may include latches that allow the lid to be fully removed from the container, or hinges which allow the lid to freely move between open and closed positions relative to the container. While a hinged connection can provide for easier use and can prevent misplacement of the lid, it can present a risk of falling into the closed position.

Various mechanisms are known for keeping a lid in an open position, however they require a user to take additional steps after the lid has been opened. Such mechanisms can include, for example, a rod or block that is placed between a lid and a container such that the lid cannot close until the rod or block has been removed. These mechanisms can also hinder access to the container because the rod or block partially blocks an access point to the opening of the container. Additionally, these mechanisms can be tedious and challenging to position the rod or block. Further, as a user accesses the container, the rod or block can be accidentally displaced from the proper position causing the lid to unintentionally close while a user is accessing the container.

Accordingly, there remains a need to retain a hinged lid in an open position while allowing the lid to be selectively closed as desired by the user.

### SUMMARY

A latch system is provided for retaining a lid in an open position.

In one embodiment, a storage system is provided having a housing and a lid coupled to the housing by at least one hinge and movable between open and closed positions. The storage system further includes a connecting ring having a first portion disposed within a guide track in the housing and a second portion coupled to the lid. The first portion can be configured to move from a first region of the guide track to a second region of the guide track in response to movement of the lid from the closed position to the open position, and a protrusion extending at least partially into the guide track can be configured to retain the first portion within the second region of the guide track to retain the lid in the open position. The lid can be movable from the open position to the closed position in response to a force applied to the lid sufficient to cause the protrusion to deflect and thereby allow the first portion of the connecting ring to move from the second region of the guide track to the first region of the guide track.

While the storage system can have a variety of configurations, in one embodiment the lid can extend substantially horizontally across a top portion of the housing and the guide track can extend substantially vertically with the first region of the guide track being closer to the lid than the second region of the guide track. In some aspects, the protrusion can have a width that increases in a direction from the first region to the second region of the guide track. In other aspects, the first and second portions of the connecting ring can be pivotally movable relative to the housing and lid, respectively.

In some embodiments, the guide track can be formed in an insert disposed within a cavity in the housing. The insert can include first and second deflectable arms configured to retain the insert within the cavity.

In other aspects, an opening can extend into the guide track and can be configured to allow the first portion of the connecting ring to be inserted into the guide track. In some embodiments, a width of the first portion of the connecting ring is greater than a width of the opening such that the first portion is configured to be snap-fit into the guide track.

In other aspects, the connecting ring can include at least one leg extending between and connecting the first portion and the second portion. In some embodiments, the connecting ring can have two legs positioned on and extending from opposed ends of the first and second portions.

In another embodiment, the protrusion can be formed on a plunger removably coupled to the connecting ring, or it can be integrally formed on the connecting ring. In some aspects, the protrusion can be disposed on a removable plunger which can be retained between opposed arms of the connecting ring.

In another embodiment, a latch assembly is provided having an insert body having a guide track therein. The guide track can have an opening for providing access to the guide track, a first region, and a second region positioned opposite the first region. The latch assembly can further include a projection extending adjacent to the guide track. At least a portion of the projection can extend into the guide track to provide a reduced width region between the first and second regions. The reduced width region can have a width that is less than a width of the first and second regions. The latch assembly can also include a connecting ring having a first portion extending through the guide track and a second portion positioned opposite the first portion and spaced away from the insert body. The second portion can be pivotally movable relative to the insert body. The first portion can have a width that is greater than the reduced width region such that a force is required to cause the projection to deflect to allow the first portion to move between the first region and the second region.

In some aspects, the width of the first portion can be greater than a width of the opening such that the first portion is configured to be snap-fit into the guide track.

In other aspects, the insert body can include first and second deflectable arms extending outward therefrom and configured to retain the insert body within an opening in a housing.

In other aspects, the projection can be formed on a plunger removably coupled to the insert body, or the projection can be formed on the insert body.

In other embodiments, the connecting ring can include a first leg extending substantially perpendicular to the first portion and extending away from the insert. The connecting ring can also include a second leg extending substantially perpendicular to the first portion and extending away from the insert. The second portion can extend between the first and second legs.

In other embodiments, the opening can be positioned adjacent to the first region.

### BRIEF DESCRIPTION OF THE DRAWINGS

These and other features will be more readily understood from the following detailed description taken in conjunction with the accompanying drawings, in which:

FIG. 1A is a side perspective view of one embodiment of a latch assembly shown in a first position;

FIG. 1B a front perspective view of the latch assembly of FIG. 1A shown in a second position;

FIG. 2A is a front perspective view of one embodiment of a storage system including the latch assembly of FIG. 1, shown with a lid in the closed position;

FIG. 2B is a perspective view of the storage system of FIG. 2B shown with the lid in the open position;

FIG. 2C is a rear perspective view of the storage system of FIG. 2A shown with the lid in the open position;

FIG. 3 is a side view of an insert of the latch assembly of FIGS. 1A and 1B;

FIG. 4 is a side view of a ring of the latch assembly of FIGS. 1A and 1B;

FIG. 5 is an exploded view of a portion of the lid and container of FIGS. 2A and 2B and the latch assembly of FIGS. 1A and 1B;

FIG. 6A is a side view of the latch assembly of FIGS. 1A and 1B shown when a lid is in the closed position;

FIG. 6B is a side view of the latch assembly of FIGS. 1A and 1B shown when a lid is in the open position;

FIG. 7A is a side view of a container and latch assembly of FIGS. 1A-2C shown with the lid in the closed position;

FIG. 7B is a side view of the latch assembly of FIGS. 1A-2C shown with the lid in the open position; and

FIG. 8 is a side view of another embodiment of a latch assembly.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. A person skilled in the art will also recognize that a value may not be precisely at a value but nevertheless considered to be substantially at that value due to any number of factors, such as manufacturing tolerances and sensitivity of measurement equipment.

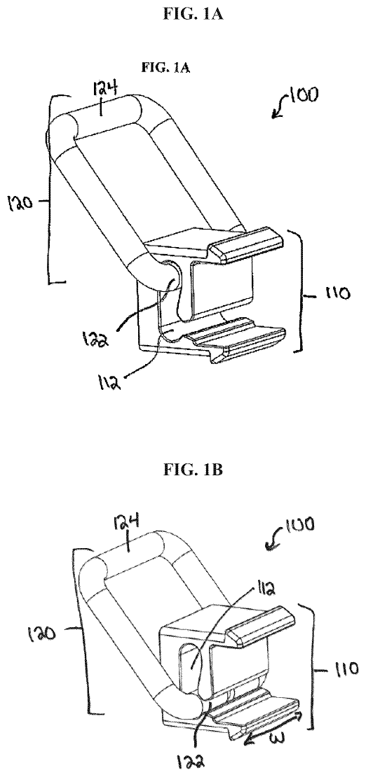

A latch assembly for use in maintaining a lid in an open position is provided. FIGS. 1A and 1B illustrate one exemplary embodiment of a latch assembly 100 having an insert 110 and a connecting ring 120. The insert 110 has a guide track 112 configured to receive a first portion 122 of the ring 120, and configured to allow the ring 120 to move between first and second positions within the guide track 112 as a lid coupled to a second portion 124 of the ring 120 moves between open and closed positions. With the ring 120 in one of the first and second positions, the guide track 112 can be configured to engage the ring 120 and thereby restrict movement of the ring 120 to hold the lid open. A force applied to the lid to move the lid to the closed position can overcome the retaining force on the ring 120, thus causing the ring 120 to move to the other of the first and second positions.

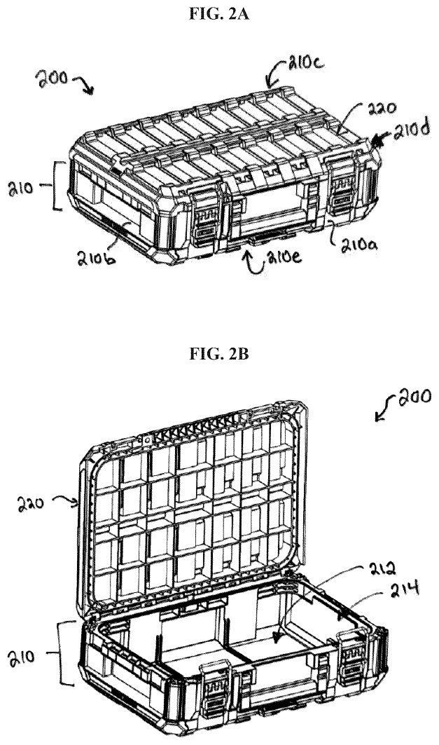

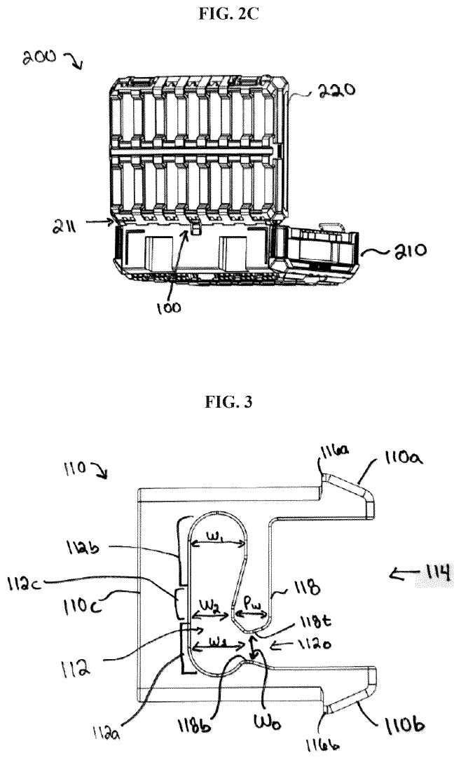

The latch assembly 100 disclosed herein can be used with any housing, container, or the like having a lid. FIGS. 2A and 2B illustrate one embodiment of a housing in the form of a tool storage system 200 having a container 210 and a lid 220. As shown, the illustrated container 210 has a generally rectangular shape with a first sidewall 210a, a second sidewall 210b, a third sidewall 210c, a fourth sidewall 210d, and a bottom wall 210e connected to all sidewalls 210a-d. The sidewalls 210a-d and the bottom wall 210e can be mated to one another or integrally formed to define a cavity 212 therein. The internal cavity 212 can be accessible by an opening 214 in the top of the container 210.

As further shown, the lid 220 can be positioned over the opening 214 and thus can likewise have a rectangular shape corresponding to the shape of the opening 214. A person skilled in the art will appreciate, however, that the shape of the lid 220 can vary based on the shape of the opening 214 and the container 210, which can likewise vary. The lid 220 can be attached to the container 210 using various techniques, but in an exemplary embodiment the lid 220 is pivotably connected to the container 210 via one or more latch assemblies and/or hinges. In the illustrated embodiment, as shown in FIG. 2C, the lid 220 is attached to the container 210 by a hinge 211, however various mating techniques can be used. Further, the lid 220 is connected to the container 210 by a single latch assembly 100, however any number of assemblies can be utilized. As shown, the insert 110 of the latch assembly 100 is disposed within or integrally formed with the container 210, and the ring 120 is coupled between the insert 110 and the lid 220. As a result of this configuration, movement of the lid 220 will cause corresponding movement of the ring 120 relative to the guide track in the insert, as will be discussed in more detail below. The guide track can thus be designed to retain the ring 120 in a fixed position when the lid 220 is open, thereby preventing the lid 220 from closing until a sufficient force is applied thereto.

FIG. 3 illustrates the insert 110 in more detail. While the insert 110 can have various configurations, in the illustrated embodiment the insert 110 is generally cube shaped but has a cut-out 114 through a central region thereof to produce a generally U-shaped body. As such, the insert 110 has opposed arms 110a, 110b extending from a base 110c. The arms 110a, 110b can be generally flexible to allow terminal ends of the arms to move toward and away from one another. Each arm 110a, 110b can optionally include a hook-shaped flange or projection 116a, 116b to allow the arms 110a, 110b to engage retention walls formed in a cavity in a container, such as container 210, to retain the insert 110 within the container 210, as will be discussed further below.

As further shown in FIG. 3, the insert 110 can include a guide track 112 extending in a direction generally perpendicular to the arms 110a, 110b and generally adjacent to the base 110c. As a result, a generally elongated projection 118 can extend between the cut-out 114 and the guide track 112, such that at least a portion of the projection 118 defines at least part of a sidewall of the guide track 112. The projection 118 can extend from the first arm 110a, but can terminate a distance from the second arm 110b to form an opening 112o between the projection and the second arm 110b. The opening 112o can be configured to allow insertion of the ring 120 into the guide track 112, while preventing removal, as discussed further below. As further shown, the insert 110 can include a second projection or nub 118b positioned opposite a terminal end 118t of the projection 118 for further defining the opening 112o.

As indicated above, the guide track 112 can be configured to control movement of the ring 120, thereby maintaining a lid coupled to the ring 120 in an open position. This can be achieved by having a width or diameter of the projection 118 and the guide track 112 vary along the length of the projection 118 and guide track 112 to control movement of the ring 120. For example, certain regions can have a reduced width to require a force to be applied to move the ring into an adjacent region. Further, the projection 118 can be flexible to allow movement of the ring 120 when a force is applied to the ring. As shown in FIG. 3, the projection 118 increases in width Pw in a direction from the first arm 110a toward the second arm 110b. The increase in width causes the guide track 112 to have a first region 112a adjacent to the opening 112o with a first width W1, a second region 112b having the same first width W1, and an intermediate region 112c between the first and second regions 112a, 112b and adjacent to a terminal end 118t of the projection 118 that has a second width W2 that is less than the first width W1. As a result, the projection 118 restricts movement of the ring 120 between the first and second regions 112a, 112b.

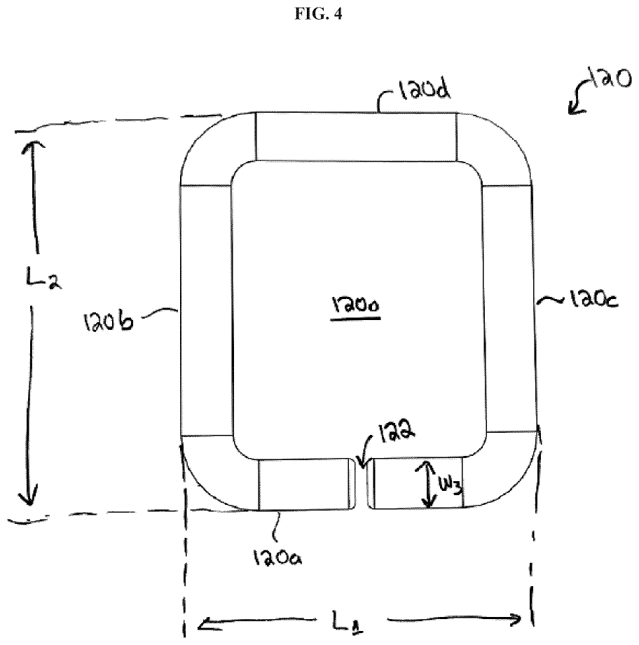

FIG. 4 illustrates the ring 120 in more detail, and as shown the ring 120 is in the form of a generally circular tube that is bent into a rectangular configuration with four sides 120a-d defining an open internal space 120o. The first side 120a can be configured to extend through the guide track 112, with the second and third sides 120b, 120c forming legs extending generally perpendicular to and away from opposed ends of the first side 120a. The fourth side 120d can extend between and connect the opposite ends of the second and third sides 120b, 120c, and the fourth side 120d can be configured to couple to a lid, as discussed further below. The length L1 of opposing sides 120a, 120d can be greater than a width W (FIG. 1B) of the insert 110 to allow the first side 120a to extend entirely through the insert 110. The length L2 of the other two opposing sides 120b, 120c can vary as needed to allow side 120d to be positioned a distance apart from the insert 110 and to mate to a lid, and to allow corresponding movement of the ring 120 within the guide track 112 during opening and closing of the lid, as discussed further below. As further shown in FIG. 4, gap 122 can be formed in one of the sides, e.g., side 120a. A person skilled in the art will appreciate that the ring 120 can have other configurations. For example, the ring 120 can have only the first, second, and fourth sides, such that a single side connects the two ends of the ring mounted to the container and lid. The ring 120 can in other embodiments have different shapes, such as circular or oval.

As indicated above, the guide track 112 and protrusion 118 are sized to control both insertion of the ring 120 into the guide track 112, and movement of the ring 120 within the guide track 112. With regard to insertion into the guide track 112, the width W3 (or diameter if round) of at least the first side 120a of the ring 120 can be slightly larger than a width Wo of the opening 112o into the guide track 112. As a result, a force sufficient to cause the projection 118 to deflect must be applied in order to insert the ring 120 through the opening 112o. Such a snap-fit connection can prevent removal of the ring 120 from the guide track 112 during use.

The width W3 of the first side 120a of the ring 120 can also be larger than the width W2 of the intermediate region 112c of the guide track 112, while being slightly smaller than the width W1 of the first and second regions 112a, 112b of the guide track 112. Such a configuration will prohibit the ring 120 from freely moving through the intermediate region 112c, thereby retaining the ring in the first or second regions 112a, 112b. As a result, a force sufficient to cause the projection 118 to deflect must be applied in order to move the ring 120 through the intermediate region 112c. Such a configuration will retain the lid in an open position during use, as discussed further below.

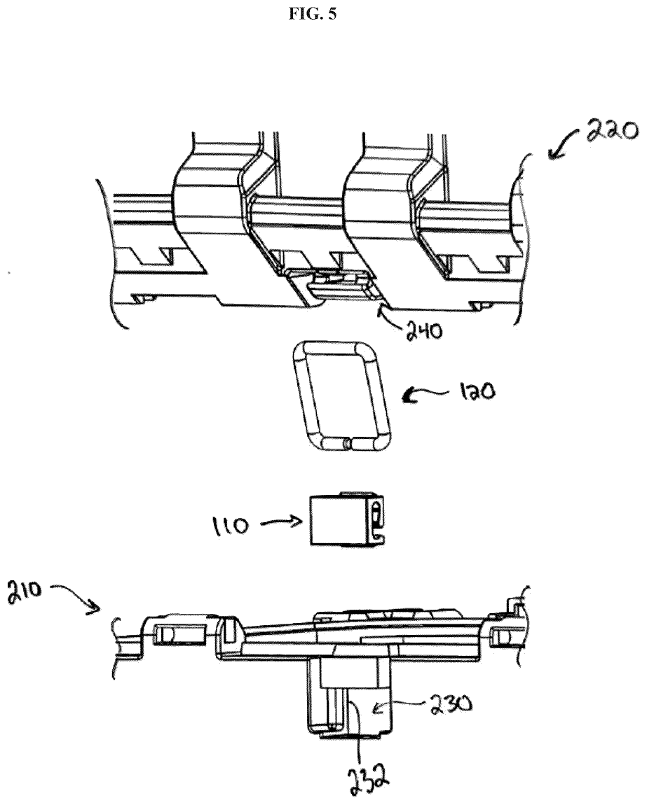

As indicated above with respect to FIG. 2C, the insert 110 can be mounted within or integrally formed with a container, such as container 210. FIG. 5 illustrates an exploded view of a portion of a back wall of the container 210 having a cavity or opening 230 configured to receive the insert 110, and a portion of a lid 220 having catch 240 configured to mate with the ring 120. The opening 230 can have a size that allows the arms 110a, 110b to compress during insertion and once the projections 116a, 116b extend past the opening 230, the arms 110a, 110b can expand to allow the projections 116a, 116b to engage retention walls of a back channel 232 of the opening 230 thereby retaining the insert 110 within the container 210. The ring 120 can have the first side 120a positioned within the guide track 112 in the insert 110, and the fourth side 120d can be inserted around the catch 240 formed in the lid 220.

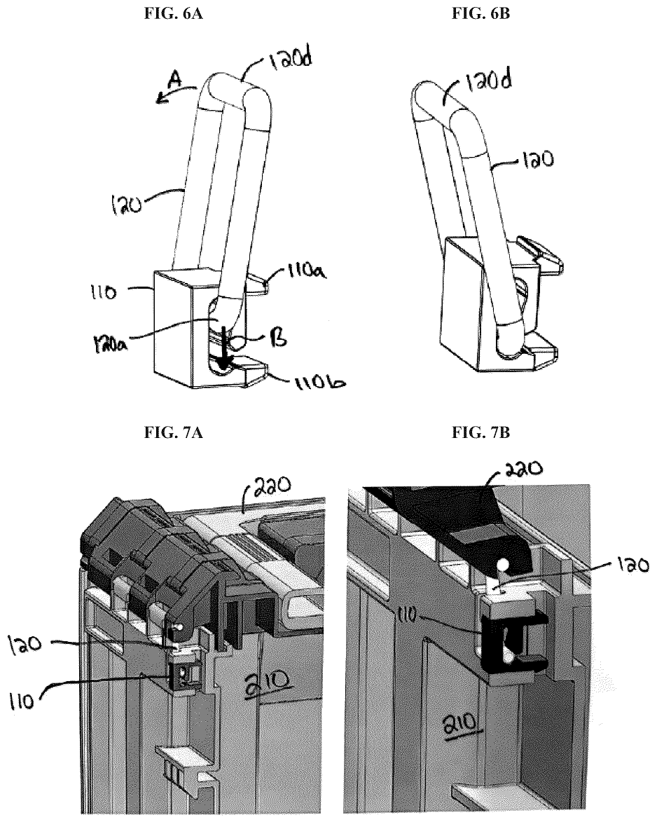

In use, when the lid 220 is closed, the first side 120a of the ring 120 is pulled up and retained within the second region 112b of the guide track 112, as shown in FIGS. 6A and 6B. Further, the fourth side 120d of the ring is angled forward toward the arms 110a, 110b of the insert 110. When the lid 220 is pivoted to the open position, as shown in FIGS. 6B and 7B, the ring 120 is angularly pivoted in the direction of arrow A (FIG. 6A), and is also pushed downward in the direction of arrow B (FIG. 6A). The force applied to move the lid 220 to the open position can create a sufficient force to cause the first side 120a of the ring 120 to move downward and pass through the intermediate region 112c having the reduced width W2, thereby overcoming the biasing force of the protrusion 118 and causing the protrusion 118 to flex out of the way and allow the ring 120 to pass. Once fully opened, the reduced width W2 of the intermediate region 112c prevents the first side 120a of the ring 120 from moving upward, thereby retaining the ring 120 in the first region 112a and thus retaining the lid 220 in the open position. As shown, the first region 112a of the guide track 112 can have a size that substantially corresponds to a size of the ring 120 to prevent substantial movement of the ring 120. This can help retain the lid 220 in a substantially fixed position.

During closing of the lid 220, a force is applied to the lid 220 that is sufficient to pivot the ring 120 forward and pull the ring 120 upward, thereby causing the protrusion 118 to flex such that the first side 120a of the ring 120 can pass through the intermediate region 112c and move back to the second region 112b of the guide track 112. As shown, the second region 112b can have a length that is sufficiently greater than the first region 112a to allow the ring 120 to move up and down, thereby allowing the lid 220 to be partially opened and closed without the need to pass through the intermediate region 112c. The user will thus only have to apply a force to move the ring 120 through the intermediate region 112c when the lid is almost fully opened, i.e., in order to move the lid 220 to the fully opened position.

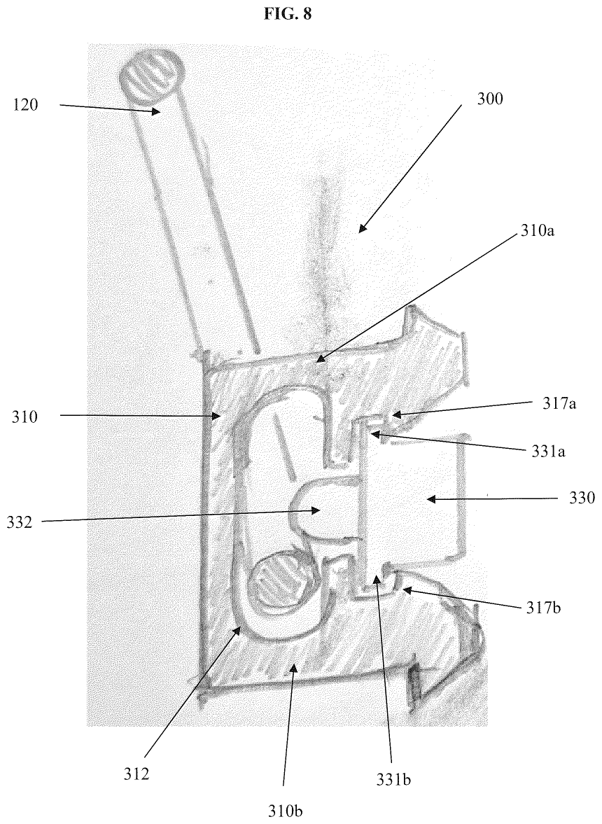

FIG. 8 illustrates another exemplary embodiment of a latch assembly 300 having an insert 310, a ring 120, and a plunger 330. The latch assembly 300 is substantially similar to latch assembly 100 described above except that the insert 310 is configured to retain the plunger 330. In particular, as shown, each arm 310a, 310b can include a groove 317a, 317b that seats a lip 331a, 331b on opposed sides of the insert 330. The plunger 330 is configured to be inserted into the insert 310 by advancing the lips 331a, 331b until sufficient force is applied to deflect the arms 310a, 310b outward, allowing the lips 331a, 331b to passthrough the opening between the arms 310a, 310ba and to extend into the grooves 317a, 317b, thereby locking the plunger 330 in the insert 310. The grooves 317a, 317b hold the insert 310 at a location that causes a projection 332 on the insert 330 to extend into the guide track 312. When the plunger 330 is retained in the insert 310, the projection 332 will act to restrict movement of the ring 120 between the first and second positions, as explained above.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described implementations. Accordingly, the present application is not to be limited by what has been particularly shown and described, except as indicated by the appended claims. All publications and references cited herein are expressly incorporated by reference in their entirety.

The present disclosure has been described above by way of example only within the context of the overall disclosure provided herein. It will be appreciated that modifications within the spirit and scope of the claims may be made without departing from the overall scope of the present disclosure.

What is claimed is:

1. A storage system, comprising:
a housing;
a lid coupled to the housing by at least one hinge, the lid movable between open and closed positions;
a connecting ring having a first portion disposed within a guide track in the housing and a second portion coupled to the lid, wherein the first portion is configured to move from a first region of the guide track to a second region of the guide track in response to movement of the lid from the closed position to the open position, and wherein a protrusion extending at least partially into the guide track retains the first portion within the second region of the guide track to retain the lid in the open position, and wherein the lid is movable from the open position to the closed position in response to a force applied to the lid sufficient to cause the protrusion to deflect and thereby allow the first portion of the connecting ring to move from the second region of the guide track to the first region of the guide track.

2. The storage system of claim 1, wherein the lid extends substantially horizontally across a top portion of the housing and the guide track extends substantially vertically with the first region of the guide track being closer to the lid than the second region of the guide track.

3. The storage system of claim 1, wherein the protrusion has a width that increases in a direction from the first region to the second region of the guide track.

4. The storage system of claim 1, wherein the first and second portions of the connecting ring are pivotally movable relative to the housing and lid, respectively.

5. The storage system of claim 1, wherein the guide track is formed in an insert disposed within a cavity in the housing.

6. The storage system of claim 5, wherein the insert includes first and second deflectable arms configured to retain the insert within the cavity.

7. The storage system of claim 1, further comprising an opening extending into the guide track and configured to allow the first portion of the connecting ring to be inserted into the guide track.

8. The storage system of claim 7, wherein a width of the first portion of the connecting ring is greater than a width of the opening such that the first portion is configured to be snap-fit into the guide track.

9. The storage system of claim 1, wherein the connecting ring includes at least one leg extending between and connecting the first portion and the second portion.

10. The storage system of claim 1, wherein the protrusion is formed on a plunger removably coupled to the connecting ring.

11. The storage system of claim 1, wherein the protrusion is integrally formed on the connecting ring.

12. A latch assembly, comprising:
an insert body having a guide track therein, the guide track having an opening for providing access to the guide track, a first region, and a second region; and
a projection extending adjacent to the guide track, at least a portion of the projection extending into the guide track to provide a reduced width region between the first and second regions, the reduced width region having a width that is less than a width of the first and second regions; and
a connecting ring having a first portion extending through the guide track and a second portion positioned opposite the first portion and spaced away from the insert body, the second portion being pivotally movable relative to the insert body, the first portion having a width that is greater than the reduced width region such that a force is required to cause the projection to deflect to allow the first portion to move between the first region and the second region.

13. The latch assembly of claim 12, wherein the width of the first portion is greater than a width of the opening such that the first portion is configured to be snap-fit into the guide track.

14. The latch assembly of claim 12, wherein the insert body includes first and second deflectable arms extending outward therefrom and configured to retain the insert body within an opening in a housing.

15. The latch assembly of claim 12, wherein the projection is formed on the insert body and at least partially defines the guide track.

16. The latch assembly of claim 12, wherein the projection is formed on a plunger removably coupled to the insert body.

17. The latch assembly of claim 12, wherein the connecting ring includes a first leg extending substantially perpendicular to the first portion and extending away from the insert.

18. The latch assembly of claim 17, wherein the connecting ring includes a second leg extending substantially perpendicular to the first portion and extending away from the insert.

19. The latch assembly of claim 18, wherein the second portion extends between the first and second legs.

20. The latch assembly of claim 12, wherein the opening is positioned adjacent to the first region.
